(19) United States
(12) Patent Application Publication
(10) Pub. No.: US 2010/0328505 A1
(43) Pub. Date: Dec. 30, 2010

(54) IMAGING DEVICE, IMAGING MODULE AND IMAGING SYSTEM

(75) Inventor: Kunihiro IMAMURA, Osaka (JP)

Correspondence Address: MCDERMOTT WILL & EMERY LLP, 600 13TH STREET, NW, WASHINGTON, DC, 20005-3096, US

(73) Assignee: Panasonic Corporation, Osaka (JP)

(21) Appl. No.: 12/880,572

(22) Filed: Sep. 13, 2010

Related U.S. Application Data
(63) Continuation of application No. PCT/JP2008/002346, filed on Aug. 28, 2008.

(30) Foreign Application Priority Data
Mar. 28, 2008 (JP) 2008-087795

(51) Int. Cl. H04N 5/335

(52) U.S. Cl. 348/273; 348/E05.091

(57) ABSTRACT

An imaging device includes a plurality of pixels which convert incident light to pixel signals which are electric charge signals and output the pixel signals, color filters which filter light incident to the respective pixels, and a pixel binning unit which bins pixel signals from pixels on adjacent lines and outputs a binned pixel signal. The color filters have a repeating pattern of a unit array corresponding to a unit of 16 pixels arranged in 4 rows×4 columns. In an image obtained from an output signal after pixel binning, the color filters constituting first pixels adjacent to each other in a row direction, and the color filters constituting second pixels having the same center-of-mass position in the row direction as that of the first pixels and being adjacent to each other in a column direction, have the same color component ratio.

### CROSS-REFERENCE TO RELATED APPLICATIONS

This is a continuation of PCT International Application PCT/JP2008/002346 filed on Aug. 28, 2008, which claims priority to Japanese Patent Application No. 2008-087795 filed on Mar. 28, 2008. The disclosures of these applications including the specifications, the drawings, and the claims are hereby incorporated by reference in their entirety.

### BACKGROUND

The present disclosure relates to imaging devices which have a large number of pixels having a pixel shift arrangement and in which signals are read with pixel binning, and imaging modules and imaging systems using the imaging devices.

There is a technique of reading out signals with pixel binning in an imaging device having a large number of pixels having a pixel shift arrangement, thereby increasing the rate of reading of a pixel signal from the imaging device or improving the sensitivity (see, for example, Japanese Patent Publication No. 2003-9166).

Japanese Patent Publication No. 2003-9166 describes a method of alternately forming a pixel row of alternate green and magenta pixels and a pixel row of alternate cyan and yellow pixels, and performing pixel addition with respect to the green pixels and the cyan or yellow pixels and performing pixel addition with respect to the magenta pixels and the yellow or cyan pixels.

### SUMMARY

In the case of pixel binning and a color filter array described in Japanese Patent Publication No. 2003-9166, a false color occurs in a Nyquist frequency on the horizontal axis of pixels which are obtained by pixel binning. Therefore, even when a process of enhancing the horizontal resolution using pixel data on upper and lower neighboring lines is performed, which is an advantage of imaging devices having a pixel shift arrangement, a sufficient level of image quality cannot be obtained.

FIG. 26 is a diagram schematically showing frequencies of a subject and points at which a false color occurs in the case of the pixel binning and color filter array of Japanese Patent Publication No. 2003-9166.

A point 261 indicates a point which has a frequency on the horizontal axis which is ¼ of that obtained when signals are read from all pixels separately and corresponds to a Nyquist frequency obtained when signals are read from binned pixels.

In the imaging device described in Japanese Patent Publication No. 2003-9166, when signals are read out with pixel binning, there is a horizontal offset sampling relationship for each line, and therefore, a resolution frequency on the horizontal axis is about twice as high as that at the point 261. Therefore, when a maximum resolution on the horizontal axis is established, a false color occurs at a point having half the frequency, resulting in low image quality.

On the other hand, an optical low-pass filter (LPF) or the like which causes the point 261 to be a null point may be incorporated to solve the aforementioned problem. In this case, however, for example, the resolution on'the horizontal axis is deteriorated, and the resolution obtained when signals are read from all pixels separately is deteriorated, and in addition, the cost is increased. Therefore, the use of the LPF is not a practical solution.

Moreover, color filters provided on pixels support only complementary colors, i.e., do not support primary colors, which are advantageous in terms of the S/N of color signals.

In view of the aforementioned problems, the detailed description describes implementations of an imaging device which has a large number of pixels having a pixel shift arrangement and in which signals are read out with pixel binning, and in which even when the sensitivity is increased by pixel binning, the occurrence of a false color and the decrease in the S/N ratios of colors are reduced or prevented, resulting in an improvement in the resolution.

An example imaging device of the present disclosure includes a plurality of pixels arranged in a matrix and each configured to convert incident light to an electric charge signal and output the electric charge signal as a pixel signal, a portion of the pixels being shifted in a row direction from another portion of the pixels (pixel shift arrangement), color filters configured to filter light incident to the respective pixels, and a pixel binning unit configured to bin pixel signals from pixels on a plurality of rows and output the binned pixel signal. The color filters have a repeating pattern of a predetermined unit array. In an image obtained from an output signal after pixel binning, the colOr filters constituting first pixels adjacent to each other in the row direction, and the color filters constituting second pixels having the same center-of-mass position in the row direction as that of the first pixels and being adjacent to each other in a column direction, have the same color component ratio.

As a result, color components after pixel binning have a phase relationship which cancels a false color.

According to the present disclosure, in an imaging device which has a large number of pixels in a pixel shift arrangement and in which signals are read out with pixel binning, the occurrence of a false color and the decrease in the S/N ratio of a color can be reduced or prevented, resulting in an improvement in the resolution, even when the sensitivity is enhanced by pixel binning.

### BRIEF DESCRIPTION OF THE DRAWINGS

FIG. 1 is a block diagram showing a functional configuration of a digital camcorder according to a first embodiment of the present disclosure.

FIG. 2 is a block diagram showing a configuration of an image sensor in the first embodiment of the present disclosure.

FIG. 3 is a timing diagram of control pulses which are applied to the imaging sensor to read out pixel signals without pixel binning in the first embodiment of the present disclosure.

FIG. 4 is a timing diagram of control pulses which are applied to read out pixel signals accumulated in horizontal transfer CCDs in the first embodiment of the present disclosure.

FIG. 5 is a timing diagram of control pulses which are applied to the imaging sensor to read out pixel signals with pixel binning in the first embodiment of the present disclosure.

FIG. 6 is a diagram showing pixel binning patterns which are used to read out pixel signals with pixel binning in the first embodiment of the present disclosure.

FIG. 7 is a diagram showing a unit array of a color filter array in the first embodiment of the present disclosure.

FIG. 8 is a diagram showing a variation of the unit array of the color filter array in the first embodiment of the present disclosure.

FIG. 9 is a diagram showing a variation of the unit array of the color filter array in the first embodiment of the present disclosure.

FIG. 10 is a diagram showing a variation of the unit array of the color filter array in the first embodiment of the present disclosure.

FIG. 11 is a diagram showing a variation of the unit array of the color filter array in the first embodiment of the present disclosure.

FIG. 12 is a diagram showing a variation of the unit array of the color filter array in the first embodiment of the present disclosure.

FIG. 13 is a timing diagram of a variation of the control pulses which are applied to the imaging sensor to read out pixel signals with pixel binning in the first embodiment of the present disclosure.

FIG. 14 is a diagram showing a variation of the pixel binning patterns which are used to read out pixel signals with pixel binning in the first embodiment of the present disclosure.

FIG. 15 is a timing diagram of a variation of the control pulses which are applied to the imaging sensor to read out pixel signals with pixel binning in the first embodiment of the present disclosure.

FIG. 16 is a diagram showing a variation of the pixel binning patterns which are used to read out pixel signals with pixel binning in the first embodiment of the present disclosure.

FIG. 17 is a timing diagram of a variation of the control pulses which are applied to the imaging sensor to read out pixel signals with pixel binning in the first embodiment of the present disclosure.

FIG. 18 is a diagram showing a variation of the pixel binning patterns which are used to read out pixel signals with pixel binning in the first embodiment of the present disclosure.

FIG. 19 is a timing diagram of a variation of the control pulses which are applied to the imaging sensor to read out pixel signals with pixel binning in the first embodiment of the present disclosure.

FIG. 20 is a timing diagram of a variation of the control pulses which are applied to the imaging sensor to read out pixel signals with pixel binning in the first embodiment of the present disclosure.

FIG. 21 is a diagram showing a variation of the pixel binning patterns which are used to read out pixel signals with pixel binning in the first embodiment of the present disclosure.

FIG. 22 is a diagram showing a relationship between the number of pixels whose pixel signals are to be binned and a detection level in a second embodiment of the present disclosure.

FIG. 23 is a diagram showing a configuration of an imaging sensor according to a third embodiment of the present disclosure.

FIG. 24 is a timing diagram of a variation of control pulses which are applied to the imaging sensor to read out pixel signals with pixel binning in the third embodiment of the present disclosure.

FIG. 25 is a diagram showing a variation of pixel binning patterns which are used to read out pixel signals with pixel binning in the third embodiment of the present disclosure.

FIG. 26 is a diagram showing a frequency at which a color moire pattern occurs in the conventional art.

FIG. 27 a diagram showing a frequency at which a color moire pattern occurs in the present disclosure.

FIG. 28 is a diagram showing a variation of the unit array of the color filter array in the first embodiment of the present disclosure.

### DETAILED DESCRIPTION

Embodiments and variations of the present disclosure will be described hereinafter with reference to the accompanying drawings. Like parts are indicated by like reference characters throughout the specification.

### First Embodiment of the Invention

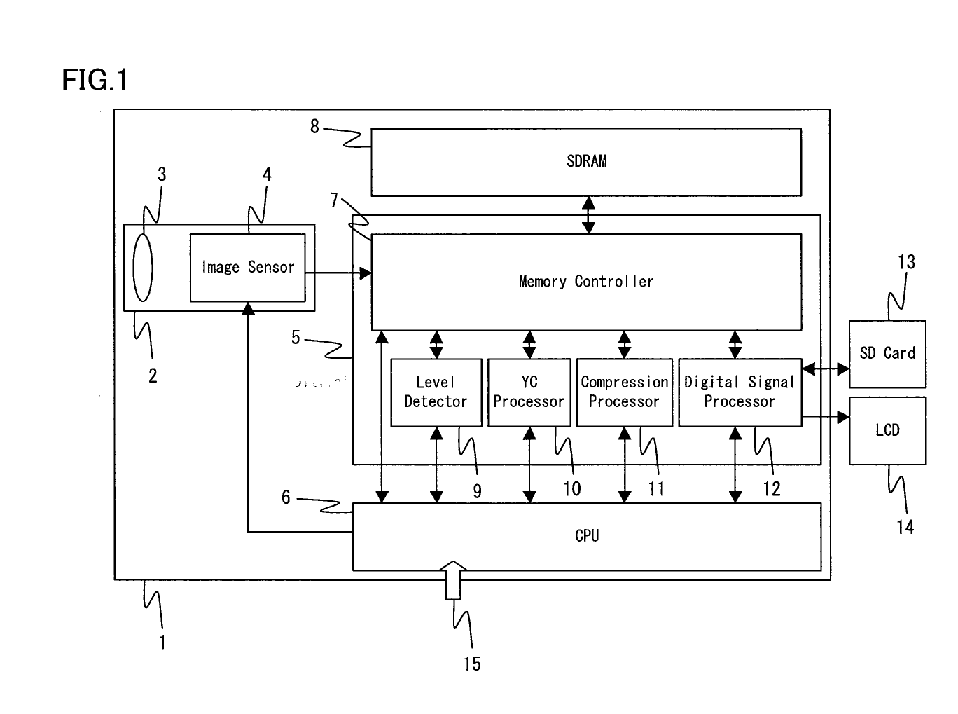

FIG. 1 is a block diagram showing a functional configuration of an imaging system according to this embodiment. The imaging system is configured as a digital camcorder 1 including an imaging module 2, a DSP 5, a CPU 6, and an SDRAM 8.

(Configuration of Imaging Module 2)

The imaging module 2 includes a lens 3 and an image sensor 4 (imaging device). Although not shown, the imaging module 2 further includes a timing generator (TG) which generates a control signal required to drive the image sensor 4, and an A/D converter which converts an imaging signal (analog signal) output from the image sensor 4 to a digital signal. The image sensor 4 can perform read operation without binning pixel signals and bin/read operation including binning pixel signals. Note that a configuration of the image sensor 4 will be described in detail later.

(DSP 5 and SDRAM 8)

The DSP 5 includes a memory controller 7, a level detector 9, a YC processor 10, a compression processor 11, and a digital signal processor 12. The DSP 5 processes an output from the image sensor 4.

The memory controller 7 writes and saves pixel signals to the SDRAM 8 until the amount of the pixel signals accumulated corresponds to a predetermined number of pixels required for a process in each of the functional blocks, i.e., the level detector 9, the YC processor 10, the compression processor 11, and the digital signal processor 12. The memory controller 7, when necessary, reads the pixel signals from the SDRAM 8 and outputs the pixel signals to the functional blocks, i.e., the level detector 9, the YC processor 10, the compression processor 11, and the digital signal processor 12. The memory controller 7 and the SDRAM 8 also write and read not only pixel signals, but also a luminance signal or a color signal obtained by YC processing, encoded data obtained by compression, and the like.

Next, the level detector 9 will be described. The level detector 9 calculates a pixel signal level from an average value or the like of pixels signals of the entire screen or a part of the screen which are output from the image sensor 4, and notifies the CPU 6 of the result of the calculation.

Next, the YC processor 10 will be described. The YC processor 10 performs synchronization, filtering, frequency correction, and the like with respect to the pixel signals output from the image sensor 4, to generate a luminance signal and a color difference signal.

Next, the compression processor 11 will be described. The compression processor 11 compresses the pixel signals output from the image sensor 4 at the RAW data level. The compression processor 11 also compresses (encodes) the luminance signal and the color difference signal generated by the YC processor 10 using a format (JPEG) for still images or another format (H.264) for moving images.

Next, the digital signal processor 12 will be described. The digital signal processor 12 reads and writes data from and to an SD card 13 which is a recording medium connected externally. The digital signal processor 12 also displays an image, such as a preview image or the like, on an LCD 14 which is a display medium. The digital signal processor 12 also performs an enlargement/reduction process (zooming) for adjusting an angle of view, and the like.

(Configuration of CPU 6)

Next, the CPU 6 will be described.

For example, the CPU 6 switches between a mode in which pixel signals are read out with pixel binning and a mode in which pixel signals are read out without pixel binning, for each of the functional blocks provided in the imaging module 2 and the DSP 5, sets a parameter for image processing in the YC processor 10, and the like. Note that an external input 15 is an input externally from a shutter-release button or an external input for setting operation of the digital camcorder 1.

(Configuration of Image Sensor 4)

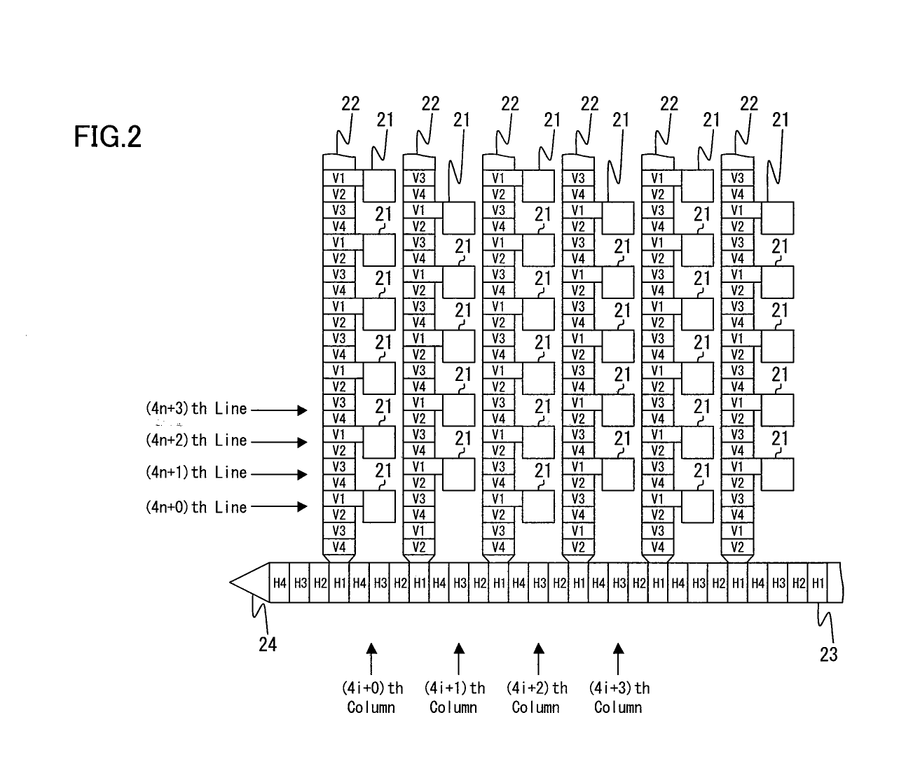

Next, the image sensor 4 will be described. FIG. 2 is a block diagram showing a configuration of the image sensor 4. As shown in FIG. 2, the image sensor 4 includes a plurality of pixels 21, vertical transfer CCDs 22, horizontal transfer CCDs 23, and an output circuit 24. Although not shown, color filters are provided on the pixels 21.

In the image sensor 4, the center of mass of each of pixels 21 on the (2n+1)th line is shifted by half a pixel from that of the corresponding one of pixels 21 on the 2n-th line. A set of vertical transfer CCDs 22 are provided for each column of pixels 21. A horizontal transfer CCD 23 is provided at one end of the corresponding set of vertical transfer CCDs 22. The output circuit 24 is provided at one end of the horizontal transfer CCDs 23.

The vertical transfer CCDs 22 each include electrodes (gates) V1-V4, and the horizontal transfer CCDs 23 each include electrodes (gates) H1-H4. The same control signal is input to the electrodes V1-V4, and the same control signal is input to the electrodes H1-H4.

The pixels 21 each convert light entering the pixel 21 to an electric charge signal which is a pixel signal (i.e., the pixel 21 performs photoelectric conversion). A pixel signal accumulated in the pixel 21 is transferred from the pixel 21 to the corresponding vertical transfer CCD 22 in accordance with a control signal input from the TG of the imaging module 2.

The pixel signals transferred to the vertical transfer CCDs 22 are successively transferred to the corresponding horizontal transfer CCD 23 in accordance with a control signal input from the TG. The pixel signals transferred to the horizontal transfer CCD 23 are transferred to the output circuit 24 in accordance with a control signal input from the TG.

In this case, when the pixel signal is read out without pixel binning, the pixel signal transferred to the horizontal transfer CCD 23 is transferred to the output circuit 24 by horizontal forward transfer. When the pixel signal is read out with pixel binning, the pixel signal transferred to the horizontal transfer CCD 23 is transferred to the output circuit 24 by a combination of horizontal forward transfer in which the pixel signal is transferred in a direction toward the output circuit 24 and horizontal backward transfer in which the pixel signal is transferred in a direction away from the output circuit 24.

The output circuit 24 converts the pixel signal, which is electric charge transferred by the horizontal transfer CCD 23, to an analog voltage signal, and outputs the analog voltage signal. The output circuit 24, the vertical transfer CCD 22, and the horizontal transfer CCD 23 constitute a pixel binning unit.

(Color Filters of Image Sensor 4)

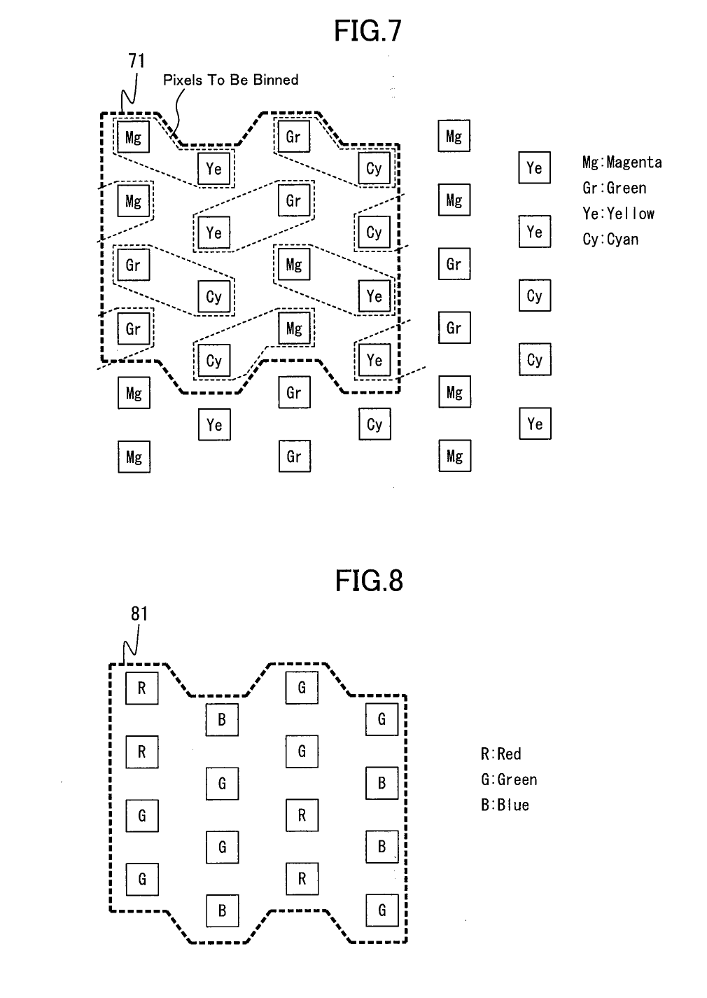

As described above, color filters are provided on the pixels 21 of the image sensor 4. FIG. 7 is a diagram for describing the color filters provided on the pixels 21 of the image sensor 4 of this embodiment.

The color filters have a repeating pattern of a unit array 71. Specifically, the unit array includes filters provided on a unit of 16 pixels arranged in 4 rows×4 columns, where each filter transmits one of first to eighth colors. In the first column, filters are arranged in the order of the first, fifth, second, and sixth colors. In the second column, filters are arranged in the order of the third, seventh, fourth, and eighth colors. In the third column, filters are arranged in the order of the second, sixth, first, and fifth colors. In the fourth column, filters are arranged in the order of the fourth, eighth, third, and seventh colors. The first and fifth colors are magenta, the second and sixth colors are green, the third and seventh colors are yellow, and the fourth and eighth colors are cyan.

In the color filters, when pixel signals are read out without pixel binning, incident light from a subject is filtered by the color filters and then converted, by the pixels 21, to electric charge signals, which are then read out as magenta (Mg), cyan (Cy), yellow (Ye), and green (Gr) pixel signals.

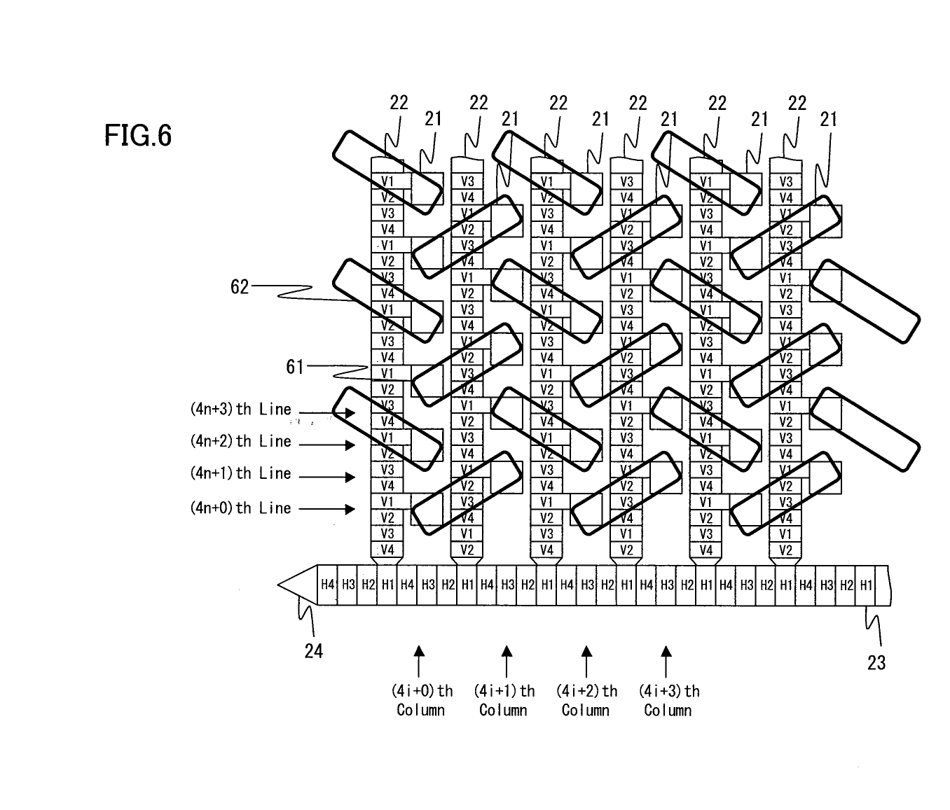

On the other hand, when pixel signals are read out with pixel binning, incident light from a subject is filtered by the color filters and then converted, by the pixels 21, to electric charge signals, i.e., magenta (Mg), cyan (Cy), yellow (Ye), and green (Gr) pixel signals. Before reaching the output circuit 24, the pixel signals are binned in pairs, i.e., Mg+Ye, Gr+Cy, Mg+Cy, and Gr+Ye, as shown in FIG. 6, and the binned pixel signals are read out.

### Operation of Digital Camcorder 1 (Imaging System)

(Overall Operation)

When shooting is performed by the digital camcorder 1, light from a subject is passed through the lens 3 to enter the image sensor 4, converted to electric charge signals by the pixels on the image sensor 4, and output as an imaging signal to the DSP 5. The imaging signal is read from or written to the SDRAM 8 via the memory controller 7. The imaging signal is also input to or output from the level detector 9, the YC processor 10, the compression processor 11, the digital signal processor 12, the SD card 13 (recording medium), and the LCD 14 (display medium) via the memory controller 7.

Specifically, the level detector 9 detects a level of the imaging signal and notifies the CPU 6 of the imaging signal level. The YC processor 10 performs filtering, synchronization, and the like with respect to the imaging signal to convert the imaging signal to a YC signal. The compression processor 11 reduces the data amount of the imaging signal or the YC signal using a compression format (JPEG, etc.) for still images or another compression format (H.264, etc.) for moving images.

The digital signal processor 12 performs signal processing required for operation of camcorders, such as zooming, defect correction, detection of the color temperature of illumination light, and the like.

On the other hand, the CPU 6 outputs a control signal required for the digital camcorder 1 to achieve operation expected by the user, to the image sensor 4, and the functional blocks of the DSP 5.

(Drive of Image Sensor 4)

A method for driving the image sensor 4 when the image sensor 4 outputs a video signal as described above will be described. As described above, the image sensor 4 has two types of operation, i.e., the operation in which pixel signals are read out without pixel binning and the operation in which pixel signals are read out with pixel binning.

Pixel Signal Read Operation Without Pixel Binning (First Read Operation)

Firstly, the case where pixel signals are read out without pixel binning will be described.

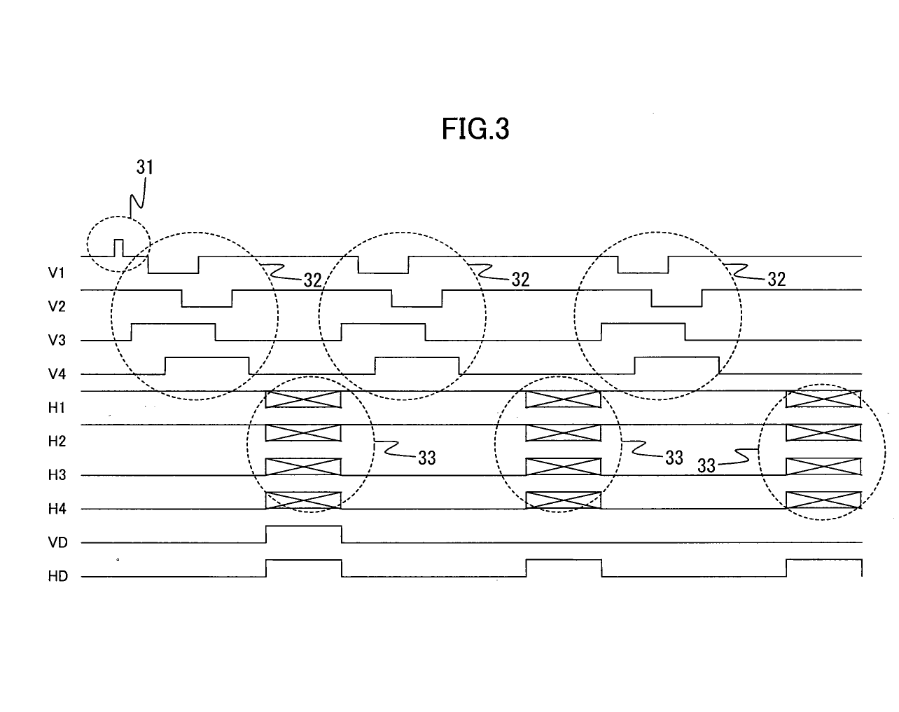

FIG. 3 shows pulses applied to the gates V1-V4 provided in the vertical transfer CCDs 22 and the gates H1-H4 provided in the horizontal transfer CCDs 23. As shown in FIG. 3, during a period 31, a read pulse having a high voltage is applied to the gates V1 in order to transfer pixel signals accumulated in the pixels 21 to the vertical transfer CCDs 22. By the read pulse, the pixel signals accumulated in the pixels 21 are transferred to the gates V1 and V2 of the vertical transfer CCDs 22.

Thereafter, during a period 32, control pulses shown in FIG. 3 are applied to the gates V1-V4 to transfer the pixel signals which have been read out from the pixels 21 to the vertical transfer CCDs 22, to the horizontal transfer CCDs 23.

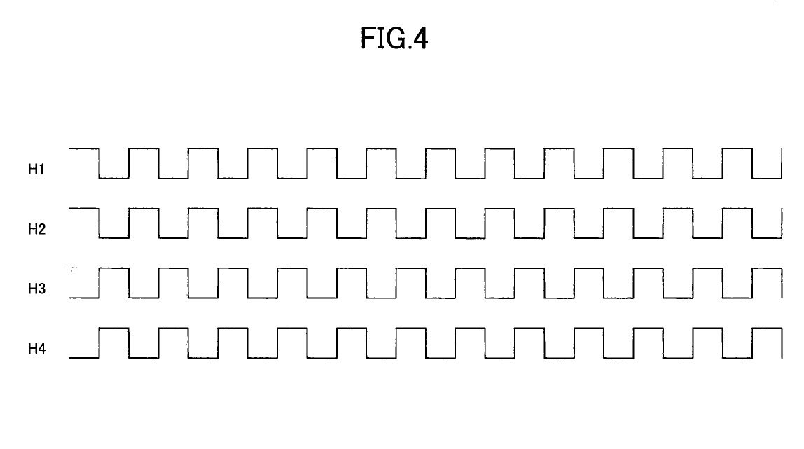

Thereafter, during a period 33, control pulses shown in FIG. 4 are applied to the gates H1-H4 of the horizontal transfer CCDs 23 to transfer the pixel signals which have been transferred from the vertical transfer CCDs 22 to the horizontal transfer CCDs 23, to the output circuit 24. The output circuit 24 converts the transferred pixel signals to analog voltage signals and outputs the analog voltage signals from the image sensor 4.

Although only a part of all periods is shown in FIGS. 3 and 4 for the sake of simplicity, the number of each type of period and the number of each type of applied pulse vary depending on the number of pixels in the image sensor 4.

Read Operation With Pixel Binning (Second Read Operation)

Next, the case where pixel signals are read out with pixel binning will be described.

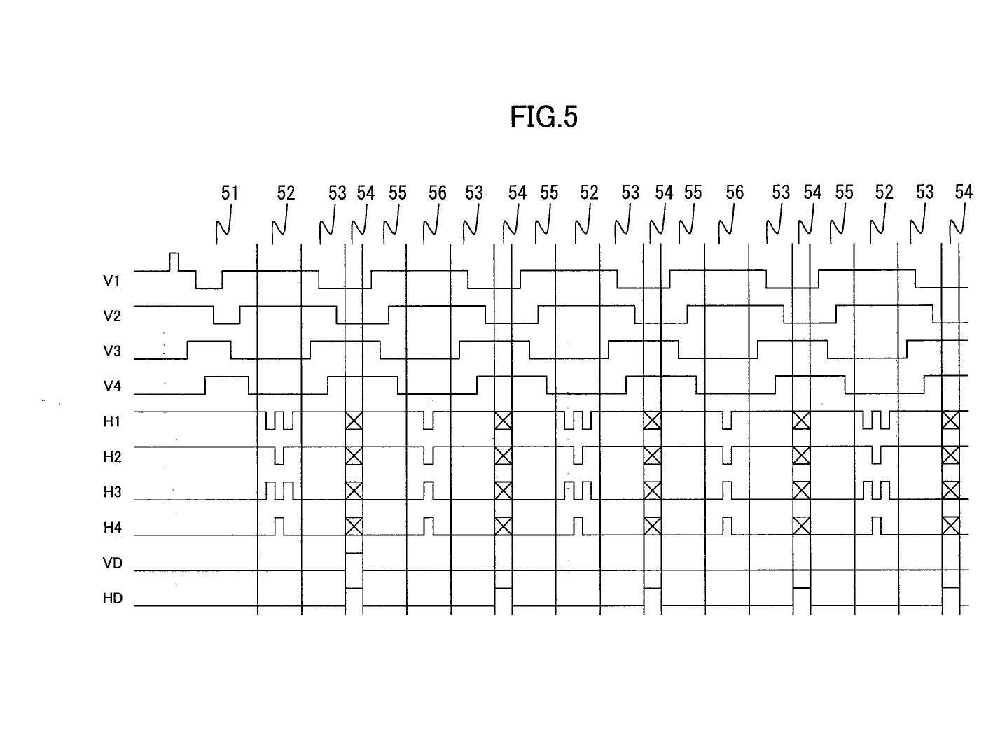

FIG. 5 shows pulses applied to the gates V1-V4 provided in the vertical transfer CCDs 22 and the gates H1-H4 provided in the horizontal transfer CCDs 23.

During a period 51, a read pulse having a high voltage is applied to the gates V1 in order to transfer pixel signals accumulated in the pixels 21 to the vertical transfer CCDs 22. By the read pulse, the pixel signals accumulated in the pixels 21 are transferred to the gates V1 and V2 of the vertical transfer CCDs 22. Thereafter, by applying control pulses shown in the period 51 to the gates V1-V4 of the vertical transfer CCDs 22, pixel signals on the 0th line are transferred to the horizontal transfer CCDs 23.

On the other hand, pixel signals on the (4n+0)th and (4n+2)th lines are transferred to the gates V1 and V2 adjacent to the pixels 21 on the (4n−2)th and (4n+0)th lines. Pixel signals on the 1st line are transferred to the gates V1 and V2 contacting the horizontal transfer CCDs 23. Pixel signals on the (4n+1)th and (4n+3)th lines are transferred to the gates V1 and V2 adjacent to the pixels 21 on the (4n−3)th and (4n+1)th lines.

Thereafter, during a period 52, control pulses shown in the period 52 are applied to the gates H1-H4 to transfer pixel signals which have been transferred to the horizontal transfer CCDs 23 contacting the (4i+0)th and (4i+2)th columns, to the horizontal transfer CCDs 23 contacting the respective adjacent (4i+1)th and (4i+3)th columns in a direction away from the output circuit 24.

Thereafter, during a period 53, control pulses shown in the period 53 are applied to the gates V1-V4 to transfer pixel signals on the 1st line to the horizontal transfer CCDs 23. Thereafter, a pixel on the 0th line and the (4i+0)th column and a pixel on the 1st line and the (4i+1)th column are binned, and a pixel on the 0th line and the (4i+2)th column and a pixel on the 1st line on the (4i+3)th column are binned (first pixel binning operation). FIG. 6 shows a pixel binning pattern 61 in this case.

On the other hand, the pixel signals which have been transferred to the vertical transfer CCDs 22 are transferred to the gates V3 and V4 adjacent in the direction of the horizontal transfer CCDs 23. Thereafter, during a period 54, control pulses shown in FIG. 4 are applied to transfer the pixel signals which have been transferred from the vertical transfer CCDs 22 to the horizontal transfer CCDs 23, to the output circuit 24, and the output circuit 24 converts the transferred pixel signals to analog voltage signals and outputs analog voltage signals from the image sensor 4. Thereafter, during a period 55, control pulses shown in the period 55 are applied to the gates V1-V4 to transfer pixel signals on the 2nd line to the horizontal transfer CCDs 23.

On the other hand, the pixel signals which have been transferred to the vertical transfer CCDs 22 are transferred to the gates V1 and V2 adjacent in the direction of the horizontal transfer CCDs 23. Thereafter, during a period 56, control pulses shown in the period 56 are applied to the gates H1-H4 to transfer the pixel signals which have been transferred to the horizontal transfer CCDs 23 contacting the (4i+0)th and (4i+2)th columns, to the horizontal transfer CCDs 23 on the respective adjacent (4i+1)th and (4i+3)th columns in the direction of the output circuit 24.

Thereafter, during a period 53, control pulses shown in the period 53 are applied to the gates V1-V4 to transfer pixel signals on the 3rd line to the horizontal transfer CCDs 23, whereby a pixel on the 2nd line and the (4i+0)th column and a pixel on the 3rd line and the (4i−1)th line are binned, and a pixel on the 2nd line and the (4i+2)th column and a pixel on the 3rd line and the (4i+1)th column are binned (second pixel binning operation). FIG. 6 shows a pixel binning pattern 62 in this case.

On the other hand, the pixel signals which have been transferred to the vertical transfer CCDs 22 are transferred to the gates V3 and V4 adjacent in the direction of the horizontal transfer CCDs 23. Thereafter, during a period 54, the control pulses of FIG. 4 are applied to transfer the pixel signals which have been transferred from the vertical transfer CCDs 22 to the horizontal transfer CCDs 23, to the output circuit 24, and the output circuit 24 converts the transferred pixel signals to analog voltage signals and outputs the analog voltage signals from the image sensor 4.

Thereafter, by applying the control pulses of FIG. 5 in a similar manner, predetermined pixels are binned, and signals obtained by binning the pixels are output as pixel signals from the image sensor 4.

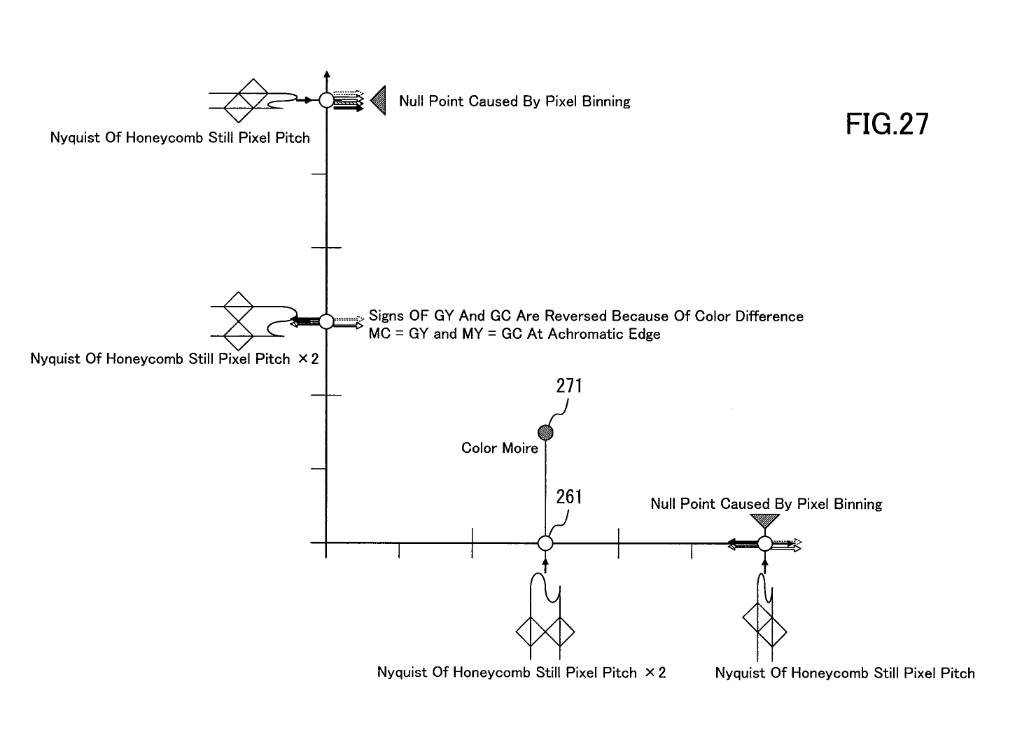

As described above, according to this embodiment, in an image obtained from output signals after pixel binning, output signals corresponding to positions arranged in the column direction have a phase relationship which cancels a false color. FIG. 27 is a diagram (spatial frequency plane) schematically showing frequencies of a subject and points at which a false color occurs in the case of the pixel binning and color filter array of this embodiment. In FIG. 27, a point 261 indicates a point which has a frequency which is ¼ of that obtained when signals are read from all pixels separately and corresponds to a Nyquist frequency obtained when signals are read out with pixel birining. At the point 261, color components after pixel binning have a phase relationship which cancels a false color, and therefore, a false color in principle does not occur. Therefore, the resolution on the horizontal axis can be increased as much as possible. Specifically, according to this embodiment, even when the sensitivity is increased by pixel binning, the occurrence of a false color and the decrease in the S/N ratios of colors are reduced or prevented, resulting in an improvement in the resolution. Note that a false color occurs at a point 271. Despite this, if an optical LPF which causes the point 271 to be a null point is incorporated in an oblique direction, a good balance of the overall resolution is obtained while a false color is reduced or prevented, although the resolution limit is decreased.

### First Variation of First Embodiment

Note that, in the unit array 71, the first and fifth colors may be red, the second, sixth, fourth, and eighth colors may be green, and the third and seventh colors may be blue.

In the foregoing description, the color filters provided on the pixels 21 of the image sensor 4 are arranged as shown in FIG. 7. When the number of color filters for the primary colors is minimized, a color filter array having a unit array 81 shown in FIG. 8 may be used. In the unit array 81, R indicates red, G indicates green, and B indicates B.

In this case, when signals are read out with pixel binning, pixel signals are binned and output in pairs, i.e., R+B (magenta), R+G (yellow), G+G (green), and B+G (cyan). When signals are read out without pixel binning, pixel signals are output as R (red), G (green), and B (blue).

### Second Variation of First Embodiment

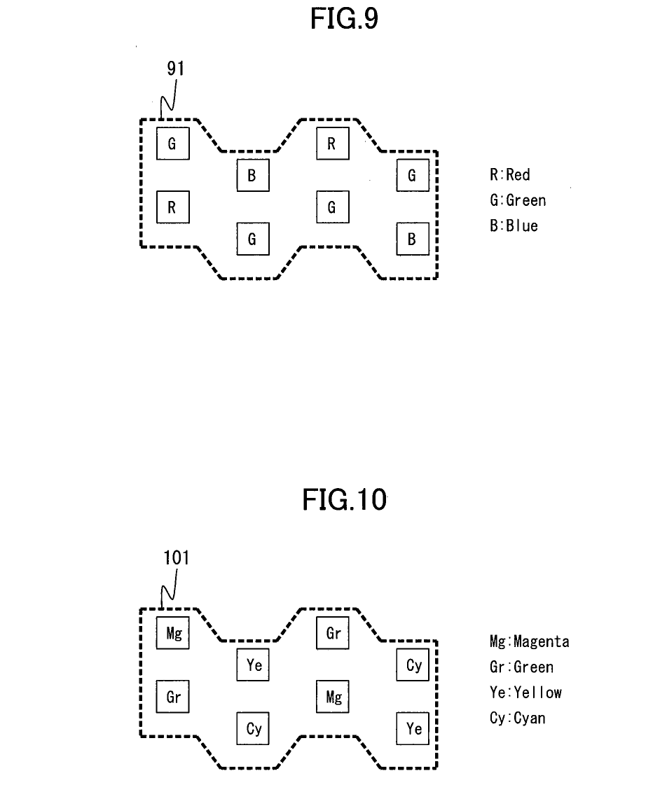

Although, in the foregoing description, the color filters provided on the pixels 21 of the image sensor 4 are arranged as shown in FIG. 7, a color filter array having a unit array 91 shown in FIG. 9 may be used.

In this case, when signals are read out with pixel binning, pixel signals are binned and output in pairs, i.e., R+B (magenta), R+G (yellow), G+G (green), and B+G (cyan). When signals are read out without pixel binning, pixel signals are output as R (red), G (green), and B (blue).

### Third Variation of First Embodiment

Although, in the foregoing description, the color filters provided on the pixels 21 of the image sensor 4 are arranged as shown in FIG. 7, a color filter array having a unit array 101 shown in FIG. 10 may be used.

In this case, when signals are read out with pixel binning, pixel signals are binned and output in pairs, i.e., Mg+Ye, Gr+Cy, Mg+Cy, and Gr+Ye. When signals are read out without pixel binning, pixel signals are output as Mg (magenta), Cy (cyan), Ye (yellow), and Gr (green).

### Fourth Variation of First Embodiment

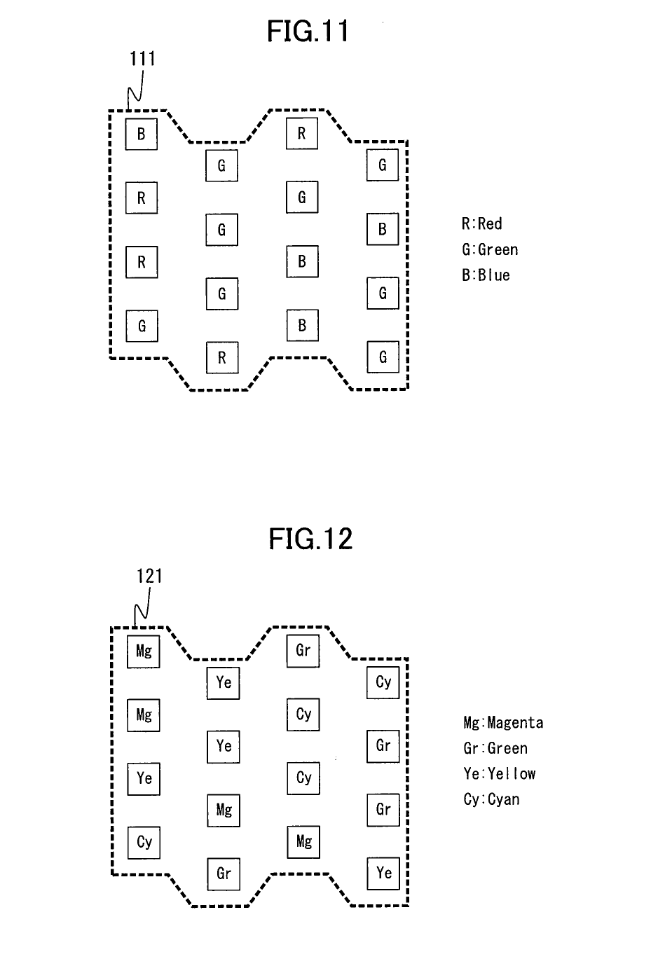

Although, in the foregoing description, the color filters provided on the pixels 21 of the image sensor 4 are arranged as shown in FIG. 7, a color filter array having a unit array 111 shown in FIG. 11 may be used.

In this case, when signals are read out with pixel binning, pixel signals are binned and output in pairs, i.e., R+B (magenta), R+G (yellow), G+G (green), B+G (cyan). When signals are read out without pixel binning, pixel signals are output as R (red), G (green), and B (blue).

### Fifth Variation of First Embodiment

Although, in the foregoing description, the color filters provided on the pixels 21 of the image sensor 4 are arranged as shown in FIG. 7, a color filter array having a unit array 121 shown in FIG. 12 may be used. Specifically, the unit array 121 includes filters provided on a unit of 16 pixels arranged in 4 rows×4 columns, where each filter transmits one of first to sixth colors. In the first column, filters are arranged in the order of the first, first, third, and fourth colors. In the second column, filters are arranged in the order of the third, fifth, first, and sixth colors. In the third column, filters are arranged in the order of the second, fourth, fourth, and first colors. In the fourth column, filters are arranged in the order of the fourth, sixth, second, and fifth colors. In this example, the first color is magenta, the second and sixth colors are green, the third and fifth colors are yellow, and the fourth color is cyan.

In this case, when signals are read out with pixel binning, pixel signals are binned and output in pairs, i.e., Mg+Ye, Gr+Cy, Mg+Cy, and Gr+Ye. When signals are read out without pixel binning, pixel signals are output as Mg (magenta), Cy (cyan), Ye (yellow), and Gr (green).

Moreover, in the case of the unit array 121, color filters having the primary colors may be used. In this case, the first color is red, the second, third, fifth, and sixth colors are green, and the fourth color is blue.

### Sixth Variation of First Embodiment

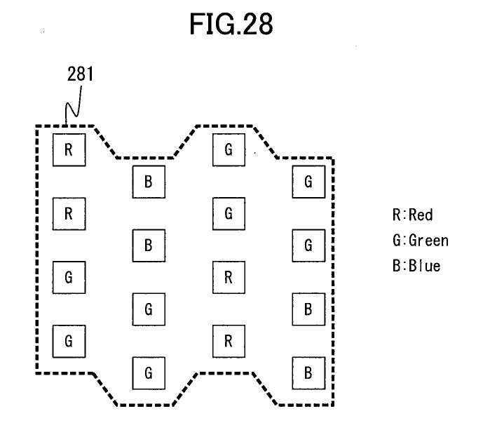

Although, in the foregoing description, the color filters provided on the pixels 21 of the image sensor 4 are arranged as shown in FIG. 7, a color filter array having a unit array 281 shown in FIG. 28 may be used.

In this case, when signals are read out with pixel binning, pixel signals are binned and output in pairs, i.e., R+B (magenta), R+G (yellow), G+G (green), and B+G (cyan). When signals are read out without pixel binning, pixel signals are output as R (red), G (green), and B (blue).

### Seventh Variation of First Embodiment

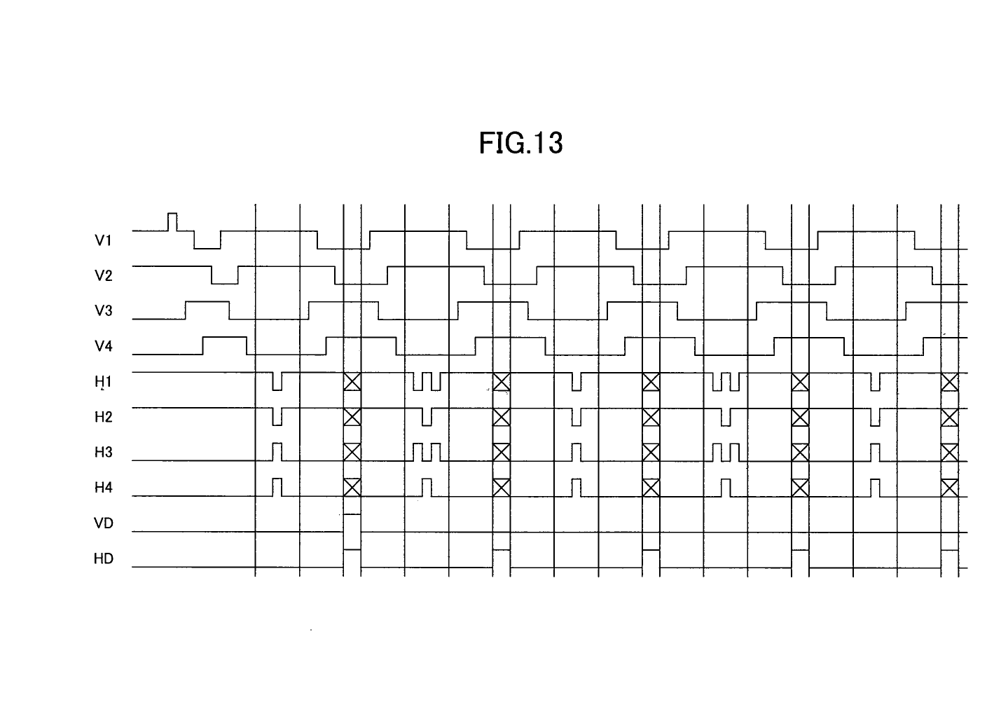

Although, in the foregoing description, the control pulses of FIG. 5 are applied to read out pixel signals of the image sensor 4 with pixel binning, control pulses shown in FIG. 13 may be used.

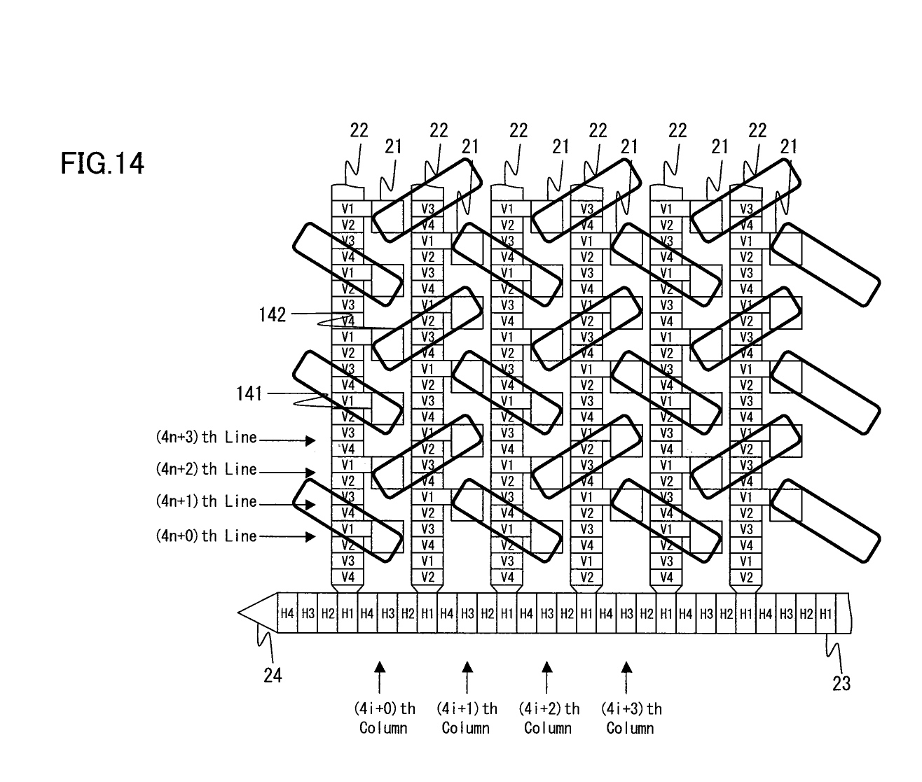

By applying the control pulses of FIG. 13, patterns and generation addresses of pixel binning may be pixel binning patterns 141 and 142 as shown in FIG. 14.

### Eighth Variation of First Embodiment

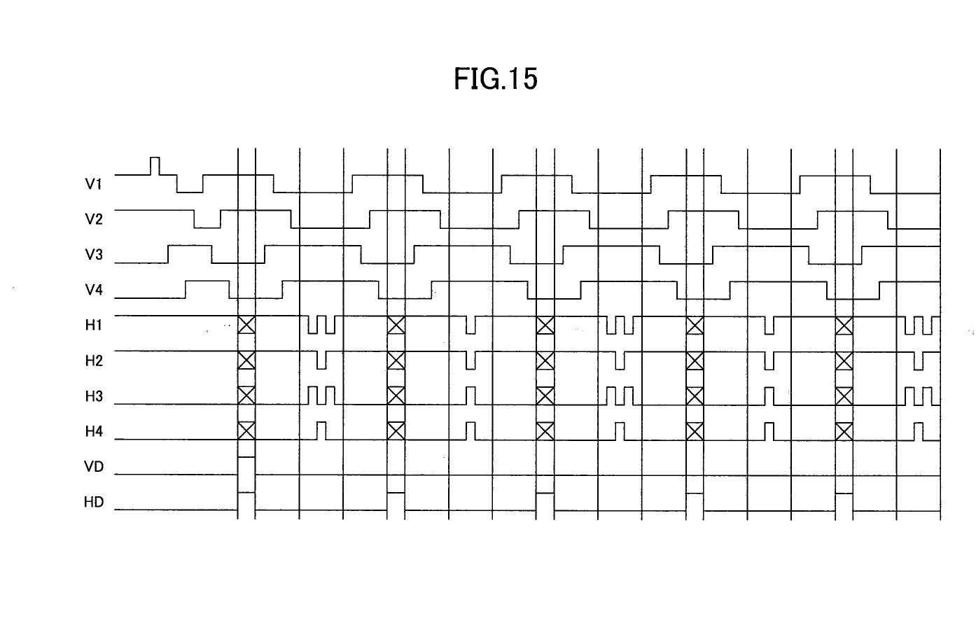

Although, in the foregoing description, the control pulses of FIG. 5 are applied to read out pixel signals of the image sensor 4 with pixel binning, control pulses shown in FIG. 15 may be used. As shown in FIG. 15, the aforementioned pixels may be binned while the 0th line is read, but the read data is not used for pixel binning.

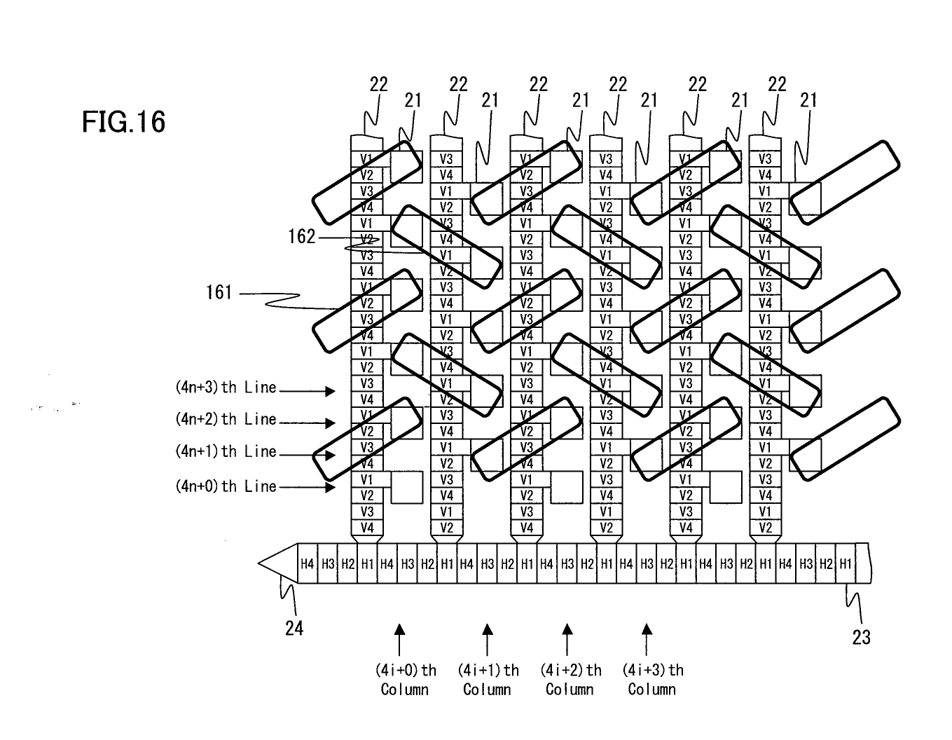

By applying the control pulse of FIG. 15, patterns and generation addresses of pixel binning may be pixel binning patterns 161 and 162 as shown in FIG. 16.

### Ninth Variation of First Embodiment

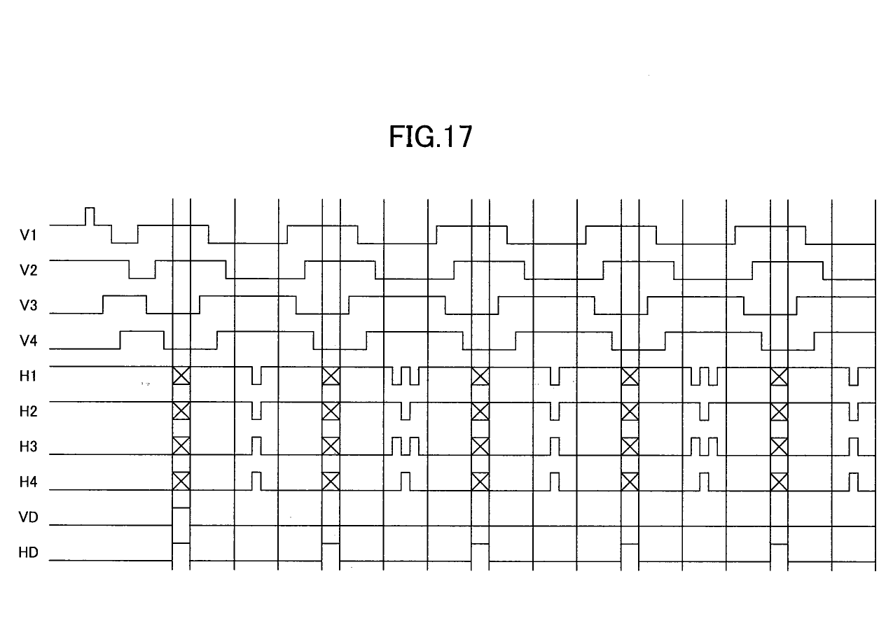

Although, in the foregoing description, the control pulses of FIG. 5 are applied to read out pixel signals of the image sensor 4 with pixel binning, control pulses shown in FIG. 17 may be used. In FIG. 17, the aforementioned pixels may be binned while the 0th line is read, but the read data is not used for pixel binning.

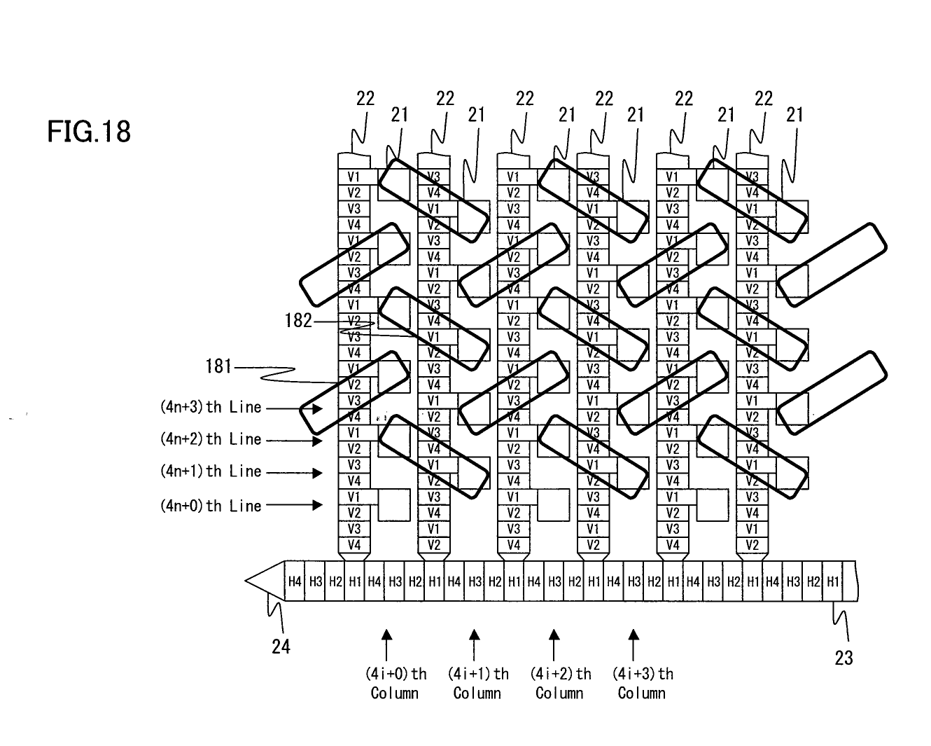

By applying the control pulse of FIG. 17, patterns and generation addresses of pixel binning may be pixel binning patterns 181 and 182 as shown in FIG. 18.

### Tenth Variation of First Embodiment

In the foregoing description, changing of pixel binning patterns is not particularly limited. Pixel binning patterns shown in the first embodiment or the seventh to ninth variations may be driven in combination every predetermined vertical blanking interval (i.e., pixel signals are read out in an interlaced manner). In this case, when a plurality of images are used to generate an image, pixels at addresses which are not present in the case of a single-frame image can be read out, resulting in a higher-definition image.

### Eleventh Variation of First Embodiment

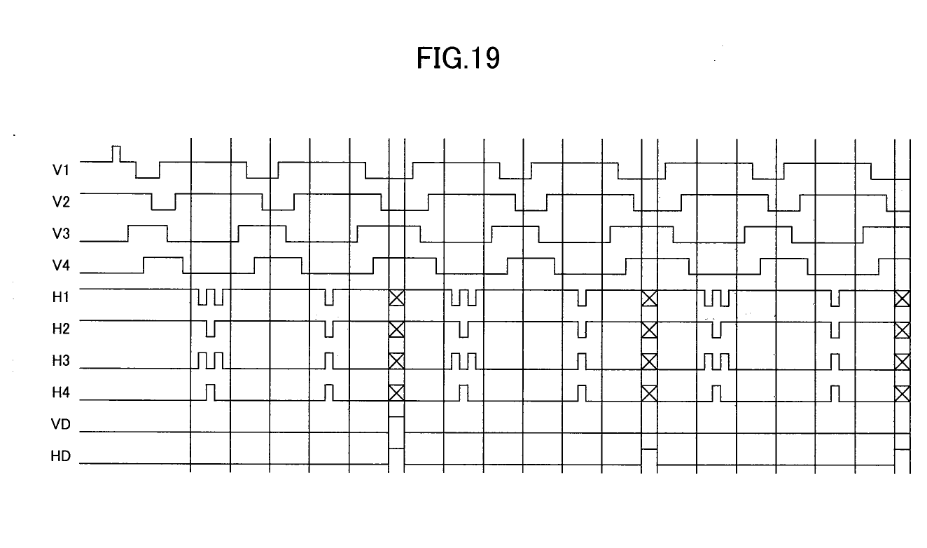

In the foregoing description, pixel signals are read from the image sensor 4 with pixel binning where a pixel on the 2n-th line and a pixel on the (2n+1)th line are binned in one horizontal blanking interval. Alternatively, control pulses shown in FIG. 19 may be applied to read pixel signals with pixel binning where a pixel on the 2n-th line and a pixel on the (2n+1)th line are binned, and a pixel on the (2n+2)th line and a pixel on the (2n+3)th line are binned, in one horizontal blanking interval.

### Twelfth Variation of First Embodiment

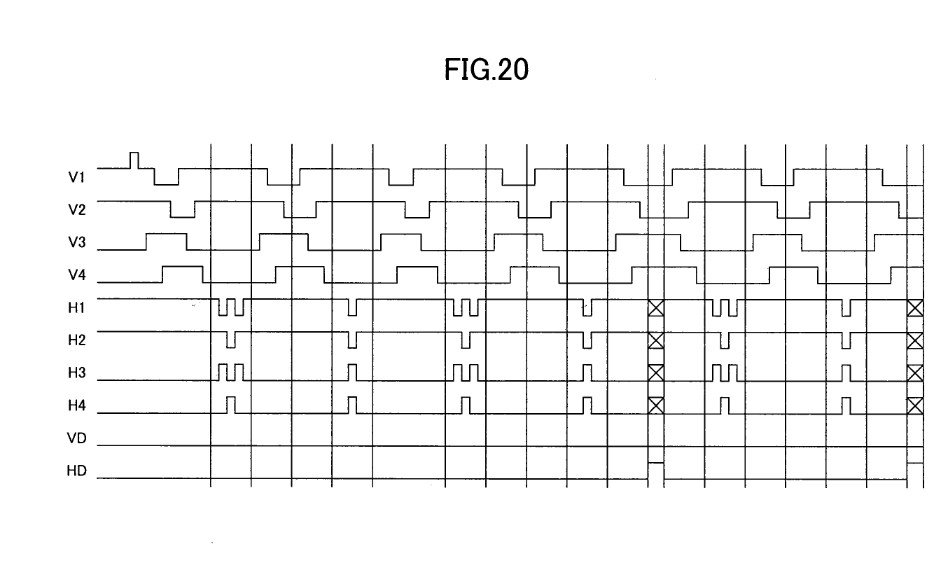

Although, in the foregoing description, the control pulses of FIG. 5 are applied to read out pixel signals of the image sensor 4 with pixel binning, control pulses shown in FIG. 20 may be used.

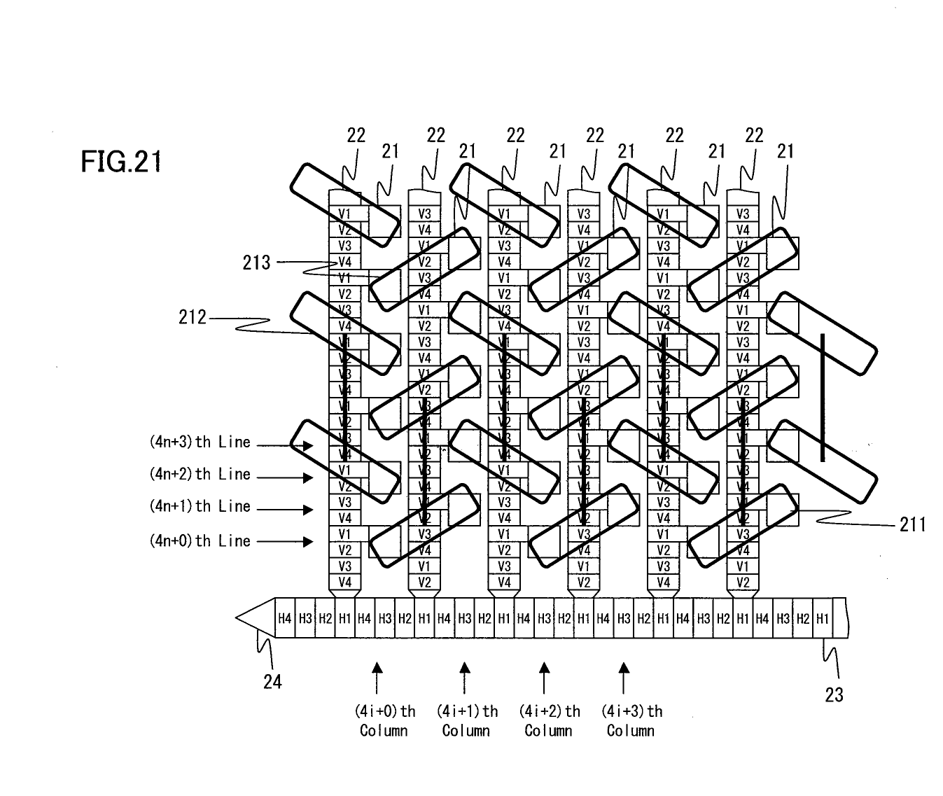

By applying the control pulses of FIG. 20, the pixel binning patterns can be changed to pixel binning patterns 211, 212, and 213 shown in FIG. 21. In particular, in the pixel binning patterns 211 and 212, binned pixel signals are further binned, i.e., four pixels are binned.

Although not shown, when pixel signals are binned by the horizontal transfer CCD 23, the pixel binning pattern may be horizontally reversed by switching between the mode in which the horizontal transfer CCD 23 transfers data in a direction toward the output circuit 24 and the mode in which the horizontal transfer CCD 23 transfers data in a direction away from the output circuit 24.

Moreover, as shown in FIG. 20, the number of pixels for which pixel signals are binned may be changed during one vertical blanking interval, or may be fixed.

Moreover, by increasing the number of gates of the horizontal transfer CCD 23, pixel signals on lines having a larger distance therebetween may be binned.

Moreover, pixel binning may be carried out by binning pixel signals using the horizontal transfer CCD 23 before reading out the pixel signals.

### Second Embodiment of the Invention

An imaging system according to a second embodiment of the present disclosure will be described. The imaging system of the second embodiment of the present disclosure has a configuration which is slightly different from that of the first embodiment. The difference will be mainly described hereinafter.

This embodiment is different from the first embodiment in that the CPU 6 controls the number of pixels of the image sensor 4 whose pixel signals are to be binned. The CPU 6 will be specifically described.

For example, the CPU 6 switches between a mode in which pixel signals are read out with pixel binning and a mode in which pixel signals read out without pixel binning, for functional blocks provided in the imaging module 2 and the DSP 5, sets a parameter for image processing in the YC processor 10, and the like.

In this embodiment, the CPU 6 notifies the timing generator (TG) (not shown) of the imaging module 2 of the number of pixel signals to be binned, depending on the result of the detection from the level detector 9. In response to this, the TG generates control pulses for driving the image sensor 4 based on the number of pixel signals to be binned notified of from the CPU 6.

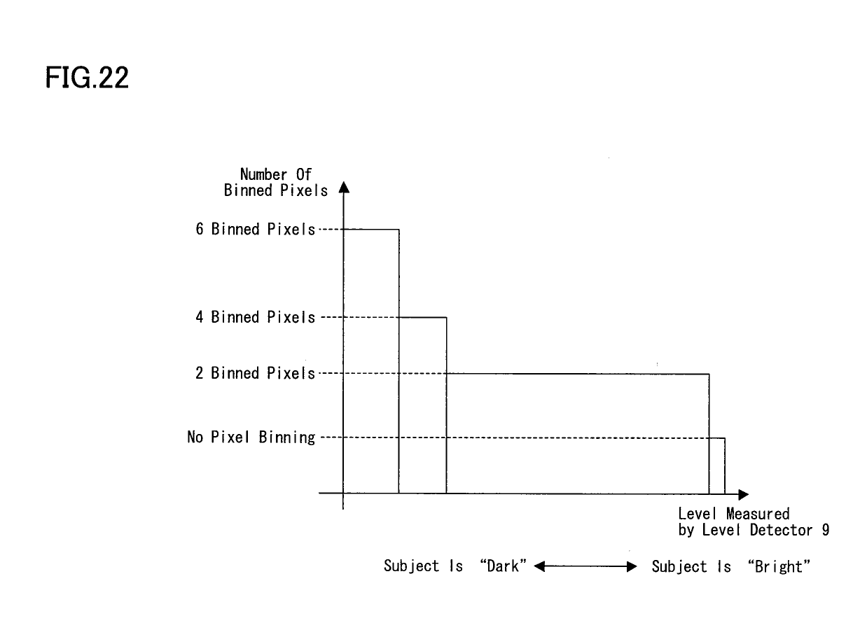

FIG. 22 shows a relationship between the result of the detection by the level detector 9 and the number of pixel signals to be binned, in the imaging system of this embodiment. The horizontal axis indicates the result of the detection by the level detector 9. As one progresses rightward on the horizontal axis, the level of an imaging signal output from the image sensor 4 increases, i.e., the brightness of a subject increases.

As shown in FIG. 22, the CPU 6 divides the brightness of a subject into groups using a plurality of thresholds. Specifically, when the result of the detection by the level detector 9 is smaller than the first threshold, pixel signals of six pixels are binned. When the result of the detection by the level detector 9 is larger than the first threshold and smaller than the second threshold, pixel signals of four pixels are binned. When the result of the detection by the level detector 9 is larger than the second threshold and smaller than the third threshold, pixel signals of two pixels are binned. When the result of the detection by the level detector 9 is larger than the third threshold, pixel signals are read out without pixel binning. In this case, the number of pixels to be binned can be increased, depending on the brightness of a subject, whereby the rate of reading of pixel signals or the sensitivity can be significantly improved.

### First Variation of Second Embodiment

Although, in the foregoing description, the number of pixel signals to be binned is 6, 4, 2, or 1 pixel, other combinations may be used.

Moreover, the number of combinations of pixel signals to be binned may be two or more instead of four.

### Second Variation of Second Embodiment

Although, in the foregoing description, the number of pixel signals to be binned by the CPU 6 is determined based only on the result of the detection by the level detector 9, the number of pixel signals to be binned by the CPU 6 may be determined based on a value specified directly by the external input 15. Alternatively, the number of pixel signals to be binned by the CPU 6 may be determined based on a combination of the value specified by the external input 15 and the result of the detection by the level detector 9, or the thresholds may be set by the external input 15.

### Third Embodiment of the Invention

An imaging system according to a third embodiment of the present disclosure will be described. The imaging system of the third embodiment of the present disclosure has a configuration which is slightly different from that of the first embodiment. The difference will be mainly described hereinafter. This embodiment is different from the first embodiment in the configuration of the horizontal transfer CCD 23 of the image sensor 4.

(1) Configuration of Imaging Sensor

Firstly, a configuration of the image sensor 4 provided in the imaging module 2 will be described.

In the image sensor 4, the center of mass of each of pixels 21 on the (2n+1)th line is shifted by half a pixel from that of the corresponding one of pixels 21 on the 2n-th line. A set of vertical transfer CCDs 22 are provided for each column of pixels 21. A horizontal transfer CCD 23 is provided at one end of each corresponding set of vertical transfer CCDs 22. The output circuit 24 is provided at one end of the horizontal transfer CCDs 23.

The vertical transfer CCDs 22 each include electrodes (gates) V1-V4, and the horizontal transfer CCDs 23 each include electrodes (gates) H1-H4. The same control signal is input to the gates V1-V4, and the same control signal is input to H1-H4.

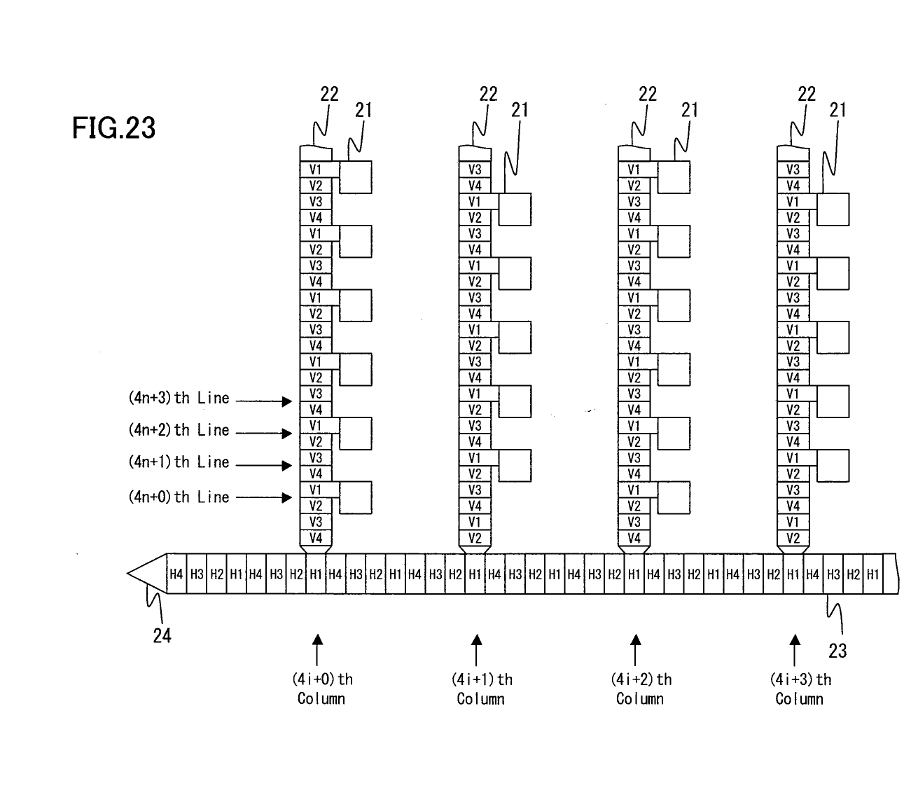

FIG. 23 shows the configuration of the image sensor 4 of this embodiment in which the horizontal transfer CCDs 23 each have a gate configuration in which two contiguous sets of gates H1-H4 are provided for each pixel column.

(2) Drive of Imaging Sensor

Next, a method for driving the image sensor 4 will be described.

A method performed when pixel signals are read out without pixel binning is almost the same, and a method performed when pixel signals are read out with pixel binning is different.

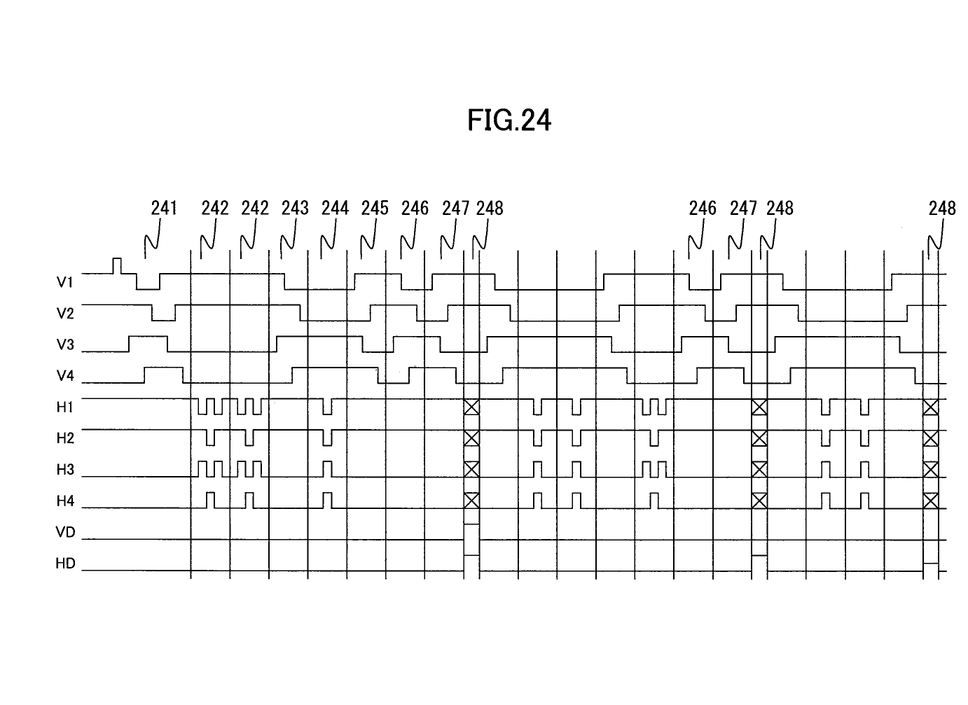

FIG. 24 shows pulses which are applied to the gates V1-V4 provided in the vertical transfer CCDs 22 and the gates H1-H4 provided in the horizontal transfer CCDs 23. During a period 241, a read pulse having a high voltage is applied to the gate V1 in order to transfer pixel signals accumulated in the pixels 21 to the vertical transfer CCDs 22.

By the read pulse, the pixel signals accumulated in the pixels 21 are transferred to the gates V1 and V2 of the vertical transfer CCDs 22. Thereafter, by applying control pulses shown in a period 51 to the gates V1-V4 of the vertical transfer CCDs 22, pixel signals on the 0th line are transferred to the horizontal transfer CCDs 23.

On the other hand, pixel signals on the (4n+0)th and (4n+2)th lines are transferred to the gates V1 and V2 adjacent to the pixels 21 on the (4n−2)th and (4n+0)th lines. Moreover, pixel signals on the 1st line are transferred to the gates V1 and V2 contacting the horizontal transfer CCDs 23, and pixel signals on the (4n+1)th and (4n+3)th lines are transferred to the gates V1 and V2 adjacent to the pixels 21 on the (4n−3)th and (4n+1)th lines.

Thereafter, during a period 242, control pulses shown in the period 242 are applied to the gates H1-H4 to transfer the pixel signals which have been transferred to the horizontal transfer CCDs 23 contacting the (4i+0)th and (4i+2)th columns, to the gates H1 and H2 of the horizontal transfer CCDs 23 located at intermediate positions of the respective adjacent (4i+1)th and (4i+3)th columns, in a direction away from the output circuit 24.

Thereafter, during a period 242, control pulses shown in the period 242 are applied to the gates H1-H4 to transfer the pixel signals which have been transferred to the horizontal transfer CCDs 23 contacting the (4i+0)th and (4i+2)th columns, to the horizontal transfer CCDs 23 contacting the respective adjacent (4i+1)th and (4i+3)th columns, in a direction away from the output circuit 24.

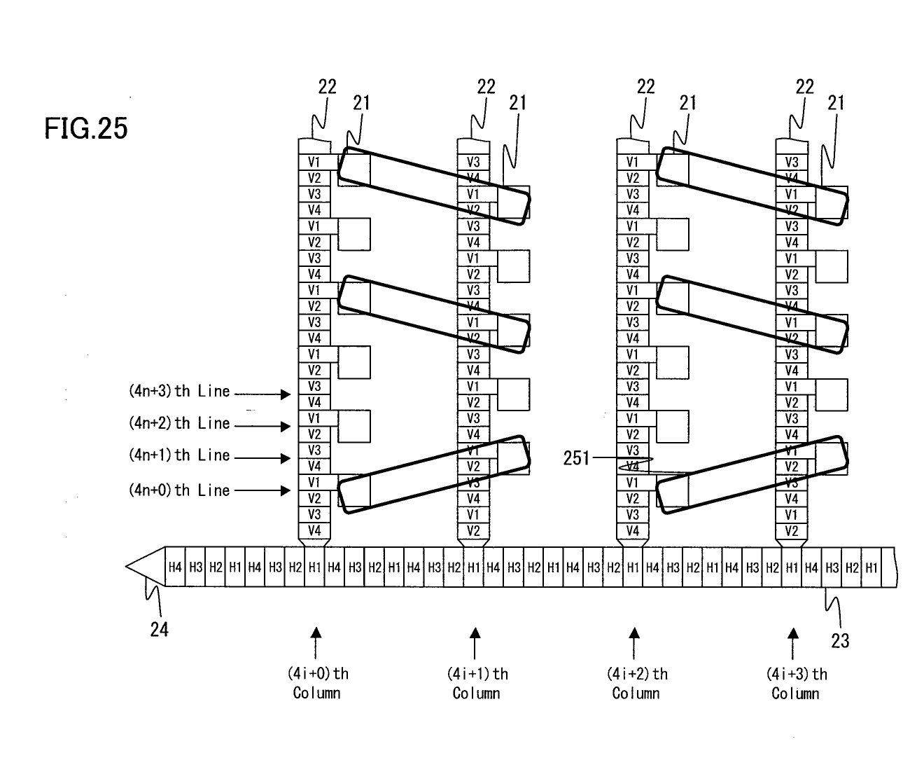

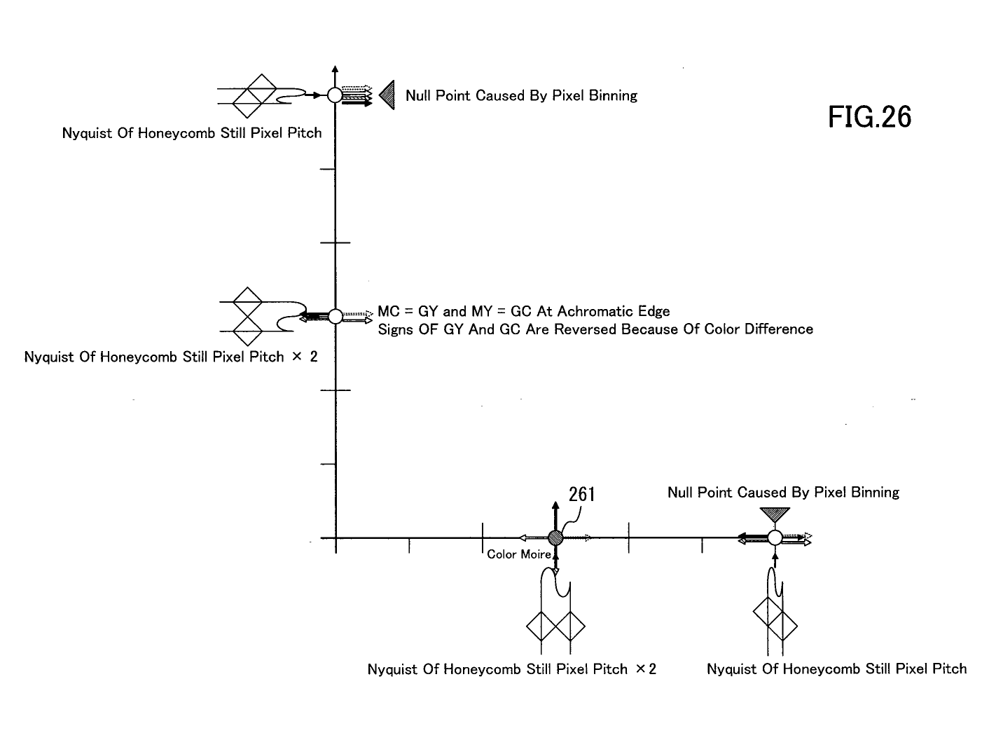

Thereafter, during a period 243, control pulses shown in the period 243 are applied to the gates V1-V4, to transfer pixel signals on the 1st line to the horizontal transfer CCDs 23, whereby a pixel on the 0th line and the (4i+0)th column and a pixel on the 1st line and the (4i+1)th column are binned, and a pixel on the 0th line and the (4i+2)th column and a pixel on the 1st line and the (4i+3)th column are binned. FIG. 25 shows a pixel binning pattern 251 in this case.

On the other hand, the pixel signals which have been transferred to the vertical transfer CCDs 22 are transferred to the gates V3 and V4 adjacent in the direction of the horizontal transfer CCDs 23.

Thereafter, during a period 244, control pulses shown in the period 244 are applied to the gates H1-H4 to transfer a pixel signal obtained by binning the pixel on the 0th line and the (4i+0)th column and the pixel on the 1st line and the (4i+1)th column and a pixel signal obtained by binning the pixel on the 0th line and the (4i+2)th column and the pixel on the 1st line and the (4i+3)th column, which have been transferred to the horizontal transfer CCDs 23 contacting the (4i+1)th and (4i+3)th columns, to the gates H1 and H2 of the horizontal transfer CCDs 23 located at intermediate positions of the respective adjacent (4i+1)th and (4i+3)th columns.

Thereafter, control pulses shown in periods 245, 246, and 247 are applied to the gates V1-V4 of the vertical transfer CCDs 22 to transfer pixel signals on the 2nd, 3rd, and 4th lines to the horizontal transfer CCDs 23.

Thereafter, during a period 248, the control pulses of FIG. 4 are applied to transfer the pixel signals which have been transferred from the vertical transfer CCDs 22 to the horizontal transfer CCDs 23, to the output circuit 24. As a result, the output circuit 24 converts the transferred pixel signals to analog voltage signals and outputs the analog voltage signals from the image sensor 4.

Subsequently, the control pulses of FIG. 24 are similarly applied to provide the pixel signal binning pattern of FIG. 25.

Although, in the foregoing description, pixels which are invalid as read pixel signals are accumulated in a place corresponding to each column in the horizontal transfer CCD 23, control pulses may be applied to accumulate only pixels which are invalid as read pixel signals, locally in a specific horizontal transfer CCD 23.

### First Variation of Third Embodiment

Although, in the foregoing description, the horizontal transfer CCDs 23 each include the gates H1-H4, the horizontal transfer CCDs 23 may each include gates H1-H8. In this case, when pixel signals are binned as in the first or second embodiment of the present disclosure, control pulses which causes each of the gate pairs of H1 and H2, H3 and H4, H5 and H6, and H7 and H8 to have the same potential, may be applied, and the transfer method may be changed to one which is different from that of the third embodiment which is performed when pixel signals are binned.

### Second Variation of Third Embodiment

Although, in the foregoing description, the horizontal transfer CCDs 23 include two contiguous sets of the gates H1-H4 each pixel column, two or more contiguous sets of the gates H1-H4 may be provided.

### Third Variation of Third Embodiment

In the foregoing description, the substrate voltage may be modulated, depending on the number of pixels to be binned so that the saturation of a photodiode constituting each pixel 21 is adjusted, depending on the number of pixels whose pixel signals are to be binned.

### Fourth Variation of Third Embodiment

Although, in the foregoing description, pixel signals for reading and discarding pixels on an invalid line are binned and output by the horizontal transfer CCDs 23, the read gates V1 of the vertical transfers CCD 22 may be divided into groups, and signals may not be read from pixels 21 belonging to some group(s).

### Other Embodiments

Note that the foregoing description is not intended to limit the present disclosure. Various changes and modifications can be made without departing the scope of the present disclosure. For example, although, in the foregoing description, the image sensor 4 is a CCD, the image sensor 4 may be a CMOS sensor or an NMOS sensor.

Moreover, the unit array of color filters provided in the image sensor 4 is not limited to those described above. The unit array of color filters may be vertically or horizontally reversed, or the color components may be replaced with other sets of color components.

The imaging device of the present disclosure have the advantage of reducing or preventing the occurrence of a false color and the decrease in the S/N ratio of a color even when the sensitivity is enhanced by pixel binning, thereby improving the resolution. The imaging device of the present disclosure is useful for imaging devices which have a large number of pixels in a pixel shift arrangement and in which signals are read out with pixel binning, and imaging modules, imaging systems, and the like including the imaging devices.

What is claimed is:

1. An imaging device comprising:
a plurality of pixels arranged in a matrix and each configured to convert incident light to an electric charge signal and output the electric charge signal as a pixel signal, a portion of the pixels being shifted in a row direction from another portion of the pixels;
color filters configured to filter light incident to the respective pixels; and
a pixel binning unit configured to bin pixel signals from pixels on a plurality of rows and output the binned pixel signal, wherein
the color filters have a repeating pattern of a predetermined unit array, and
in an image obtained from an output signal after pixel binning, the color filters constituting first pixels adjacent to each other in the row direction, and the color filters constituting second pixels having the same center-of-mass position in the row direction as that of the first pixels and being adjacent to each other in a column direction, have the same color component ratio.

2. The imaging device of claim 1, wherein
the unit array includes filters each configured to transmit one of first to eighth colors and provided on a unit of 16 pixels arranged in 4 rows×4 columns,
the first column includes filters arranged in the order of the first, fifth, second, and sixth colors,
the second column includes filters arranged in the order of the third, seventh, fourth, and eighth colors,
the third column includes filters arranged in the order of the second, sixth, first, and fifth colors, and
the fourth column includes pixels arranged in the order of the fourth, eighth, third, and seventh colors.

3. The imaging device of claim 1, wherein
the unit array includes filters each configured to transmit one of first to sixth colors and provided on a unit of 16 pixels arranged in 4 rows×4 columns,
the first column includes filters arranged in the order of the first, first, third, and fourth colors,
the second column includes filters arranged in the order of the third, fifth, first, and sixth colors,
the third column includes filters arranged in the order of the second, fourth, fourth, and first colors, and
the fourth column includes filters arranged in the order of the fourth, sixth, second, and fifth colors.

4. The imaging device of claim 2, wherein
in the unit array, the first and fifth colors are magenta, the second and sixth colors are green, the third and seventh colors are yellow, and the fourth and eighth colors are cyan.

5. The imaging device of claim 2, wherein
in the unit array, the first and fifth colors are red, the second, sixth, fourth, and eighth colors are green, and the third and seventh colors are blue.

6. The imaging device of claim 3, wherein
in the unit array, the first color is magenta, the second and sixth colors are green, the third and fifth colors are yellow, and the fourth color is cyan.

7. The imaging device of claim 3, wherein
in the unit array, the first color is red, the second, third, fifth, and sixth colors are green, and the fourth color is blue.

8. The imaging device of claim 2, wherein
in the unit array, the first and fifth colors are red, the second, sixth, fourth, and seventh colors are green, and the third and eighth colors are blue.

9. The imaging device of claim 3, wherein
in the unit array, the first color is red, the second, third, fifth, and sixth colors are green, and the fourth color is blue.

10. The imaging device of claim 2, wherein
in the unit array, the first and fifth colors are red, the second, sixth, fourth, and eighth colors are green, and the third and seventh colors are blue.

11. The imaging device of claim 1, wherein
the pixel binning unit is configured to read out the pixel signals in an interlaced manner.

12. The imaging device of claim 1, wherein
the pixel binning unit is configured to bin pixel signals of three or more pixels.

13. The imaging device of claim 1, wherein
the pixel binning unit is configured to read out the pixel signals while skipping a predetermined row or rows.

14. The imaging device of claim 1, wherein
the pixel includes a CCD, a CMOS, or an NMOS.

15. The imaging device of claim 1, further comprising:
a level detector configured to detect a level of a pixel signal read out from each pixel, wherein
the pixel binning unit changes the number of pixels to be binned, depending on the pixel signal level detected by the level detector.

16. The imaging device of claim 1, wherein
the pixel binning unit is configured so that the number of pixels to be binned can be externally changed.

17. An imaging module comprising:
the imaging device of claim 1; and
a lens, wherein
the imaging module outputs a video signal.

18. An imaging system comprising:
the imaging module of claim 17; and
a digital signal processing circuit configured to process the video signal output by the imaging module.
